(19) United States
(12) Patent Application Publication
(10) Pub. No.: US 2009/0150171 A1
(43) Pub. Date: Jun. 11, 2009

(54) Automatic e-mail delivery, mutli-media marketing software program

(76) Inventors: Terry W. Honroth, Sarasota, FL (US); Andrea J. Honroth, Sarasota, FL (US)

Correspondence Address: BERENATO, WHITE & STAVISH, LLC, 6550 ROCK SPRING DRIVE, SUITE 240, BETHESDA, MD, 20817, US

(21) Appl. No.: 12/324,812

(22) Filed: Nov. 26, 2008

Related U.S. Application Data
(60) Provisional application No. 61/012,512, filed on Dec. 10, 2007.

(51) Int. Cl. G06Q 10/00

(52) U.S. Cl. 705/1

(57) ABSTRACT

The present invention is a marketing program system that has a database storing critical action dates, inputted by individuals requesting information, that trigger automatic deliveries from program system users' media files and generic media files to requesting individuals. It is hosted on a server with protected login accessibility by participating businesses and has numerous functions to follow the logical progress from inquiry, sale and repeat business, continuing to serve the individual until they opt-out. The functions are triggered both automatically and/or manually by participating program users with cancellation and deletion capability. The program is customer friendly and intended to assist a customer or potential customer by delivering information requested in a timely manner. An individual must have access to a computer and e-mail address to receive the deliveries since the deliveries are primarily static or static & flash presentations, PDF documents, Word documents and other electronic media delivered via e-mail.

### BACKGROUND OF THE INVENTION

1. Field of the Invention

The invention relates generally to an automatic e-mail delivery, multi-media marketing software program.

2. Background

Currently there are a number of solutions for marketing businesses via the Internet. Some of these solutions attempt to provide cursory interactions with a prospect/customer/guest, but these solutions fail to meet the needs of the industry because they do not use proper marketing tools to encourage initial and ongoing business with their potential and existing customers. Other solutions attempt to inform or stay in touch during the active stages of commerce, but these solutions are similarly unable to meet the needs of the industry because they fail to perpetuate the client relationship as a means of expansion and increased revenue. Still other solutions seek to gain repeat business, but these solutions also fail to meet industry needs because they do not provide a complete professional marketing program which delivers all of the appropriate, timely information that a business should do and would like to do, but cannot afford to do with their existing staff and methods. Nor is it economically feasible for them to add additional personnel to accomplish what this invention provides.

It would be desirable to have a computerized process utilizing an interactive web based system for an interaction between a resort/hotel/timeshare type property and a prospect/customer/guest utilizing a web client with stored industry type/user type data, prospect/customer/guest management data, e-mail and presentations delivery data, program user and generic media file data, area interests data and a web server which responds automatically and immediately (without involving a staff member) to a prospect/customer/guest inquiry, delivering the appropriate information via an e-mail with professional web delivered property presentations that solicit a response from the prospect/customer/guest. Furthermore, it would also be desirable to have a computerized process that can capture all of the pertinent prospect/customer/guest data necessary to provide subsequent automatic, computerized deliveries timed to the events in the process of availability confirmation, reservation confirmation, check-in, departure, return invitations, and holiday greetings. Still further, it would be desirable to have a computerized process for itinerary planning by polling the prospect/customer/guest to determine their interests while visiting the area. Still further, it would be desirable to have a computerized process that can automatically deliver survey forms and suggestion forms to the prospect/customer/guest that solicit a response for the purpose of improving property and guest services. Therefore, there currently exists a need in the industry for a process that captures all of the data necessary for a resort/hotel/timeshare type property to deliver automatically, and in an appropriately timed manner, to a prospect/customer/guest, all of the information necessary for a positive guest experience, thereby turning first time guests in to repeat guests, resulting in increased revenue. Fulfilling this need, affordably, by using technology to stay in touch with the prospect/customer/guest and delivering all of the marketing tools and features that a resort/hotel/timeshare type property should do and would like to do, but can't afford to do with existing staff and methods.

### SUMMARY OF THE INVENTION

The present invention advantageously fills the aforementioned deficiencies by providing an automatic e-mail delivery, multi-media marketing software program which assists with business inquiries by providing automatic e-mail delivery responses. The software of the present invention engages a prospective client by delivering information and interactive responses that will pursue, and then maintain, an ongoing business relationship.

While the present invention is not limited to use in a reservation scenario, reservation scenarios are particularly illustrative of exactly how the invention can be implemented. For example, in the case where the present invention is implemented to facilitate communication in a vacation rental property scenario, the automatic deliveries are scheduled and can be triggered by the arrival and departure dates captured in the programs database and the date of the first inquiry. The deliveries, themselves, are preferably e-mail based with static and/or flash developed web page presentations attachments specific to the individual vacation rental property.

By way of illustrative example, a vacation rental property, such as but not limited to a hotel or resort, would be able to respond immediately to a guest inquiry, automatically, even after office hours. The program would deliver availability information, confirm a reservation and offer a virtual concierge service for the guest. It would deliver check-in information, a “Thank You” upon departure asking for the completion of a survey and/or suggestions that would improve the guest services and encourage a return visit. At an appropriate, predetermined date, the program would automatically invite the guest to a return visit to the property, send a Seasons Greeting message and invite the guest to return again.

In general terms, since the software program is geared for businesses in various industries, including, but not limited to, the following industries: Hospitality (hotels, motels, bed and breakfasts, condominiums, condominium resorts, time-shares, vacation homes, and other rental properties), Attractions/Recreation, Real Estate, Builder/Developer, and Retirement facilities, there are different optional features depending on the type of business.

In the case of the hospitality industry, there are several default deliveries that can be selected for automatic transmission to the guest or potential guest, all of which can be scheduled in advance. For example, if a potential guest does not reply to an availability confirmation, a follow-up e-mail can be automatically sent. If the potential guest does not respond or book the reservation after notification that they have availability, and the arrival date passes, the guest can receive a delivery thanking them for their interest, expressing regrets that were not able to visit their facility and encourages them to consider the property next time. If the guest books a reservation, but cancels before the arrival date, the guest can automatically receive an invitation to visit the property in the future. If a guest becomes undesirable to the property owner, the guest can be deleted from the database. All of the guests and potential guests can also automatically receive appropriate seasonal and/or holiday messages, as well as birthday or anniversary messages.

The present invention system is unique when compared with other known systems and solutions in that it gives immediate and timed, automatic, e-mail responses with professional attachments to a prospect/customer/guest beginning with an initial inquiry, continuing through the entire process, to the completion of the business transaction. This includes a virtual concierge service that polls for area interests and automatically responds to their requests.

The present invention system, using the hospitality industry as an example, is unique due to the presence of:

1) immediate response to an inquiry
2) response to availability request
3) reservation confirmation response
4) interest request/vacation planning/vacation photos video
5) check-in information
6) FAQ's, policies, rules & regulations, current weather conditions
7) check-out information, survey, suggestions, invitation to return
8) season's greetings, invitation to return
9) invitation to return based on initial inquiry date
10) various defaults (failed to book, cancelled reservation, undesirable guest deletion)
Similarly, the associated software is unique when compared with other software solutions in that it incorporates the delivery of all the proper marketing tools for a participating business at the appropriate time, professionally and automatically.

Accordingly, it is an object of the present invention to provide an automatic e-mail delivery, multi-media marketing software program that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1: is a schematic view of the invention

FIG. 1a: is a block diagram of the invention.

FIG. 2: is a chart identifying the hospitality industry.

FIG. 3: is a delivery sequence.

FIG. 4: describes the User Set-up.

FIG. 5: is an overview of the Inquiry function.

FIG. 5a: shows the variables of the Inquiry function.

FIG. 5a-1: describes the Inquiry function—from a program user's website.

FIG. 5a-2: describes the Inquiry function—from a direct contact from a customer.

FIG. 5a-3: describes the Inquiry function—from a program user's timed deliveries.

FIG. 5a-4: describes the Inquiry function—from a program user's default deliveries.

FIG. 6: is an overview of the Check Availability function.

FIG. 6a: shows the variables of the Check Availability function.

FIG. 6a-1: describes the Check Availability function—from a program user's website.

FIG. 6a-2: describes the Check Availability function—from a direct contact from a customer.

FIG. 6a-3: describes the Check Availability function—from a program user's timed deliveries.

FIG. 6a-4: describes the Check Availability function—from a program user's default deliveries.

FIG. 7: describes the Confirm Reservation function.

FIG. 7a: describes the Confirm Reservation function—from a direct contact from a customer.

FIG. 8: describes the Cancelled Guest function.

FIG. 9: describes the Check-in function.

FIG. 10: describes the Deleted Guest function.

FIG. 11: describes the Departure function.

FIG. 12: describes the Return Visit Invitation function—timed to the customer's Inquiry date.

FIG. 13: describes the Seasons Greetings function.

FIG. 14: is an overview of the Default Delivery function.

FIG. 14a: shows the variables of the Default Delivery function.

FIG. 14a-1: describes the No Response default function.

FIG. 14a-2: describes the Cancelled Guest default function.

### DETAILED DESCRIPTION OF THE INVENTION

The present invention is directed to an automatic e-mail delivery, multi-media marketing software program.

In its most complete version, the automatic e-mail delivery software program with a comprehensive database provides a pro-active, marketing system for businesses in various industries to have the ability to communicate everything their business would (and should) want to communicate to a potential and/or existing customer, but doesn't have the time or manpower to do so. It provides the best possible interaction between the business and its customer, seamlessly and professionally, thereby encouraging a long term business relationship. It is made up of the following components:

A) Client identity data
B) Client media file
C) Generic media file
D) Presentation deliveries
E) E-mail deliveries

These components are combined together to create an architecture for the system whereby the program administrator uses the Client Identity Data to initiate a password protected account for a business participating in the program. The administrator pulls from the Client Media File and the Generic Media File appropriate information to set-up the various e-mail deliveries for the program. The program will then deliver to the business prospect/customer, automatically at the appropriate time, the e-mail deliveries with links to the specified Presentation Deliveries bearing the business identity set-up by the administrator. It should further be noted that:

A) Client media file is comprised of information normally communicated to the customer. For example, in the case of a rental property client: Rental Agreements, Deposit Requirements, Payment Type, Rules & Regulations, Check-in and Check-out Instructions, Frequently Asked Questions, Map/Directions, Weather Forecast, etc.
B) Generic media file (in the case of a rental property client): Events Calendar, Interests Response/Vacation Planning, Animated Slide Show DVD of vacation photos, and Send to Friend delivery capability.
C) Presentation Deliveries: Web pages, including static web pages, audio/visual flash presentations, videos, slide shows, PDF documents, flyers, and/or any other type of Internet delivery presentation designed to mirror the participating business Internet website identity.
D) Timely, programmed deliveries tied to an individual's e-mail address and, in the case of a rental property client, an arrival and departure date.

In general terms, the software program is geared for businesses in various industries, including, but not limited to, the following industries; Hospitality (hotels, motels, bed and breakfasts, condominiums, condominium resorts, time-shares, vacation homes, and other rental properties), Attractions/Recreation, Real Estate, Builder/Developer, and Retirement facilities. There are different optional features depending on the type of business.

It is a method of receiving information from individuals expressing an interest in a participating business, then delivering some or all of the pertinent information to the individuals using information from the business media file and/or a generic media file stored in a comprehensive database.

The inquiry from an individual to a business using this program can be initiated in various ways;

A) From a request link on a participating business website.

B) Through a direct e-mail to the business.

C) By a telephone call to the business.

D) Through any other normal means of communication to the business.

In the A) example above, the individual making the inquiry via a submission form on a participating business website will receive an immediate, automatic e-mail response with the appropriate information delivery. In the other methods, the business would log into the program and initiate the appropriate delivery. Once the program is activated by one of the aforementioned manners, it will continue to deliver all of the marketing information the business has programmed to be delivered to the individual, at the appropriate time.

Using the hospitality industry as an example, the typical deliveries can be, but are not limited to, the following deliveries:

1) Immediate e-mail response to an inquiry from an individual for more information regarding a rental property. The e-mail response would have an appropriate media attachment (web pages, including static web pages, audio/visual flash presentations, videos, slide shows, PDF documents, flyers, and/or any other type of Internet delivery presentation and can be similar in design to the participating businesses Internet website identity) promoting the property and encouraging the potential guest to advise their desired arrival and departure dates.
2) A response to the individual's requested dates, stating availability, outlining rates and deposit requirements via e-mail with media attachments) with encouragement for the guest to make a reservation.
3) Reservation Confirmation e-mail upon satisfaction of deposit/credit requirements with an appropriate media attachment outlining detail of the reservation. The media attachment would also poll the guest for their interests in the area in an effort to assist the guest in planning their activities while visiting.
4) An automatic response to their checked interests would be delivered immediately to the guest with media attachments for each interest. This information would automatically be delivered again with the check-in information delivery.
5) Check-in information is delivered automatically, at the appropriate time, via e-mail with media attachment(s) outlining pertinent information regarding the specifics of the property. The requested area interests captured by the program would be identified and the appropriate attachments would also be included.
6) At check-out, an e-mail delivery would be sent to the guest, automatically, thanking them for their visit. The attached media would encourage the guest to complete a survey form indicating their level of satisfaction with their visit, as well as a suggestion form allowing the guest to recommend how the property and/or guest services could be improved. The guest would also be invited to return to the property for another visit.
7) Based on the original inquiry date, at the appropriate time, the program will deliver an e-mail inviting the guest to return to the property for another visit.
8) A Seasons Greetings e-mail will be sent to the guest during the holidays from the property reminding them of their visit to the property.

Regarding this invention, the program is set-up by the administrator choosing the best possible marketing tools available to them for each individual business using the program. Although the basic structure is set for each different type of business, it has the flexibility to treat every business within a specific category separately and distinctly from one another. A generic media file and a is media file specific to a participating business is created to accomplish this.

Professional presentations are created in the form of web pages, flash presentations with voice-overs, PDF documents, flyers, etc. The presentations communicate the features of the rental property and emphasize the benefits to the guest. These presentations and/or other forms of media are delivered with e-mail responses to all guest interactions and are designed to stay in touch with the guest (customer/potential customer) turning first-time guests into repeat guests.

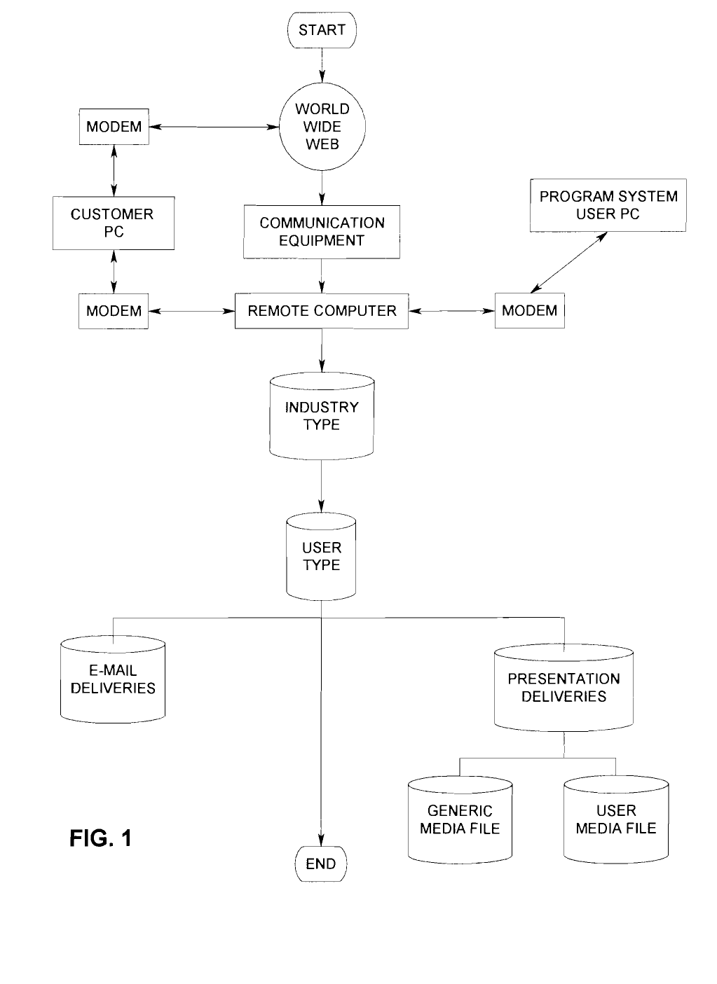

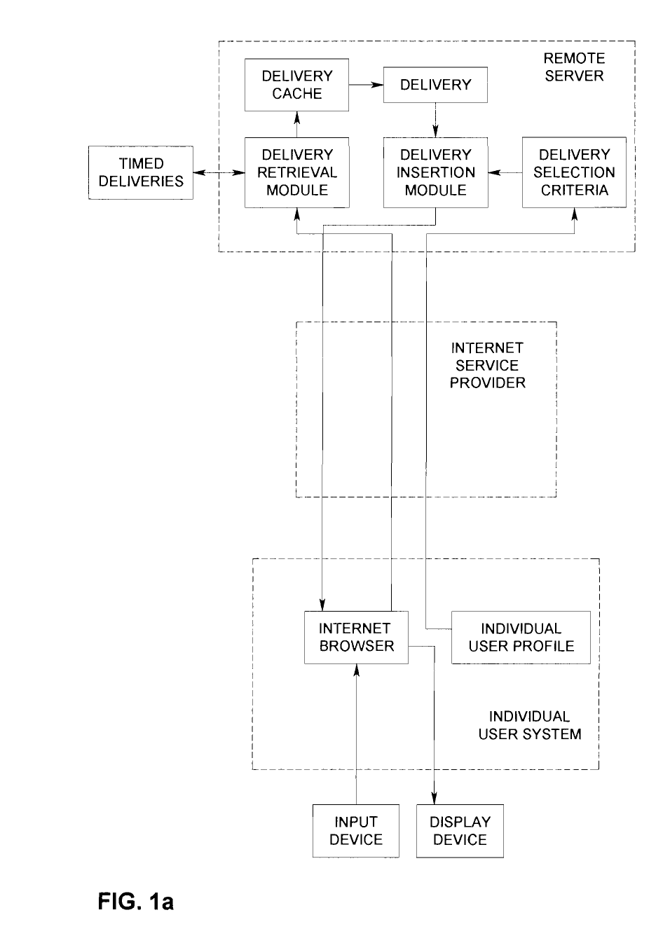

Turning now to the drawings, FIG. 1 is a schematic view of the present invention regarding an automatic e-mail delivery software program system with a comprehensive database providing a pro-active marketing system for businesses in the hospitality industry and various other industries.

FIG. 1a is a block drawing of the invention showing the user input, delivery selection, insertion, retrieval, display, and delivery process of the invention through an interaction of the customer, program system, and the participating user.

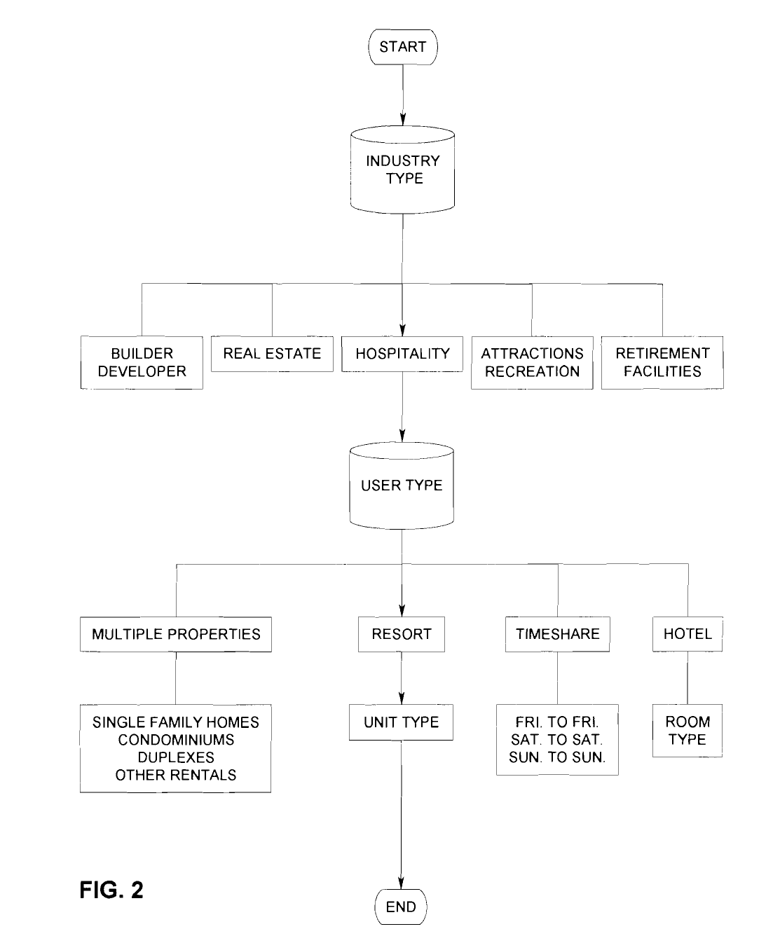

FIG. 2 is a flow chart of the present invention depicting how it relates to various industries while concentrating on the hospitality industry. Once the hospitality industry, for example, is chosen, the variables relating to that module are shown with the specific criteria within the program system.

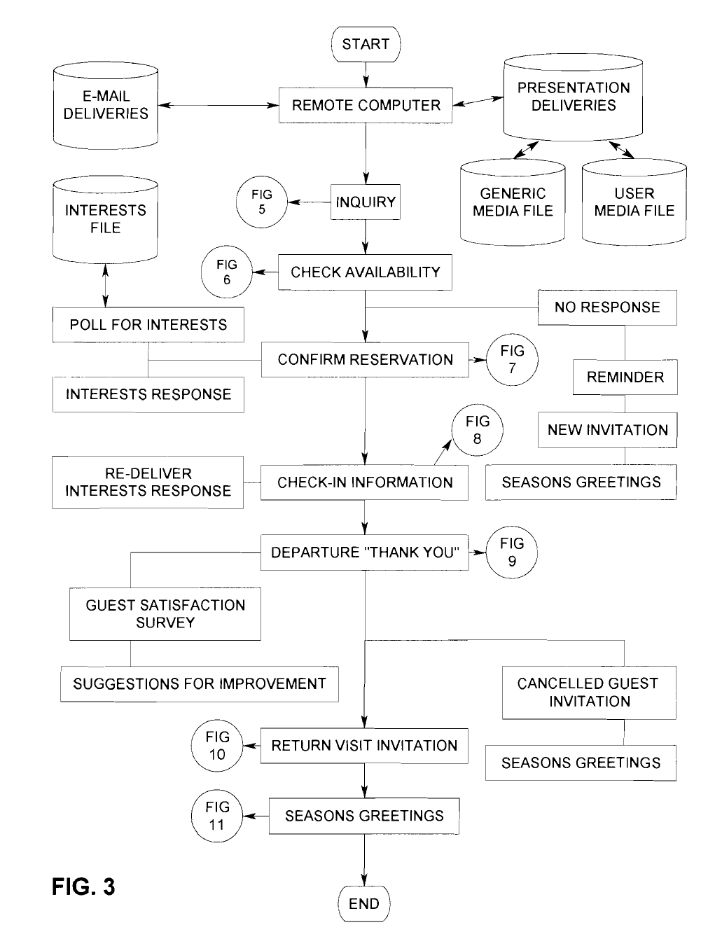

FIG. 3 is a chart showing the delivery sequence of the invention as it relates to the hospitality industry. The basic sequence, as shown, is followed throughout the module, from the initial inquiry through reservation confirmation, check-in, check-out, and all follow-up and default deliveries. The software program is comprised of some or all of, but not limited to the following components and steps:

Step 1) IMMEDIATE RESPONSE TO AN INQUIRY—An individual (guest/prospect/customer) seeking information can make an inquiry by obtaining and completing a simple form from a participating program system user's website that asks for the individual's name (optional) and e-mail address. The form is sent via the Internet directly into the software program whereby the program acknowledges the receipt of the form and advises the individual to check their inbox for an immediate response to the request. Alternatively, a participating program system user's administrator can log into the program and insert an individual's e-mail address manually in response to a phone call, e-mail or other means of communication. The program automatically selects and delivers an e-mail response with the appropriate data from its database, and the proper presentation from the participating program system user's media file in the form of a static and/or flash presentation, PDF document or other Internet related method of communication, to the individual. This e-mail will typically ask the individual for a specific reply by completing and submitting a different request form, which is received by the participating program system user in the form of an e-mail via the Internet.

Step 2) RESPONSE TO INDIVIDUAL'S REQUEST—The program system user's staff member receives the individual's (guest/prospect/customer) reply via e-mail from the request form, or alternatively by telephone, e-mail or any other method of communication. The staff checks the requested information, logs into the software program, selects the appropriate function which, in turn, initiates the appropriate delivery responding to the request, if it applies. The program also sends a different static and/or flash presentation, or other Internet related presentation of the specific business encouraging the individual to respond appropriately to the e-mail delivery they receive.

Default 1) If the individual does not respond in a timely manner, the program automatically delivers an e-mail reminder that the requested reply was not received and asks if the individual is still interested. The individual is given links to the appropriate submission form and instructions how to contact the program system user by other communication means.

Default 2) If the individual does not respond by the time fixed by the request, the program automatically delivers the appropriate e-mail with regrets and an invitation to respond to the program system user at a time in the future.

Step 3) REQUESTED INFORMATION CONFIRMATION—Upon receipt of the requested information, deposit, funding, and/or other required action by the individual (guest/prospect/customer), the program system user's staff logs into the software program, selects the appropriate function which, in turn, initiates the appropriate e-mail to the individual confirming receipt of the requirement, along with a different static and/or flash presentation of the participating program system user which confirms receipt and also assists the individual in planning activities and/or other possible interests in the area by polling the individual for their specific area interests. The individual can select from a list of many and various different interests by checking the appropriate check boxes on a form and clicking the submit button. The individual will immediately receive a message to check their inbox for a response to their requested interests.

Step 4) Individual's Interests—The program system automatically delivers from its database to the requesting individual (guest/prospect/customer), an immediate e-mail response with links to the appropriate web pages hosted on the program system's server in answer to the specific interests and activities checked by the individual.

Step 5) Timely Information—Based on the dates for action captured by the program system from the individual (guest/prospect/customer) and/or by the program system user, the program system automatically sends the proper presentation, from the participating program system user's media file stored in the program system's database, in the form of a static and/or flash presentation, PDF document or other Internet related method of communication, to the individual. This delivery can also be initiated by the program system user through the software program's administrator.

Step 5a) Individual's Interests—Along with the timely Information delivered in Step 5, the program automatically re-delivers the information on all of the requested interests and activities that were previously requested by the individual (guest/prospect/customer) in Step 4.

Step 6) Follow-up Information/Survey/Suggestions—At the appropriate time, based on the timeline stored in the software program, after the individual (guest/prospect/customer) has received the services provided by the participating program system user through the software program, an e-mail with the appropriate data from its database is sent automatically to the individual along with the proper presentation from the participating program system user's media file in the form of a static and/or flash presentation, PDF document or other Internet related method of communication. This delivery generally thanks the individual for their business and offers a survey form and a suggestion form for the individual to complete and submit, which is received by the participating program system user in the form of an e-mail via the Internet. It also encourages the individual to use the program system user's services again by inviting them to complete a new “Information Request” form.

Step 7) Invitation to Become a Repeat Customer—At the appropriate time, based on the timeline stored in the software program tied to the initial inquiry by the individual, the program automatically delivers an e-mail inviting the individual program system user (guest/prospect/customer) to participate, again, in the program system user's services.

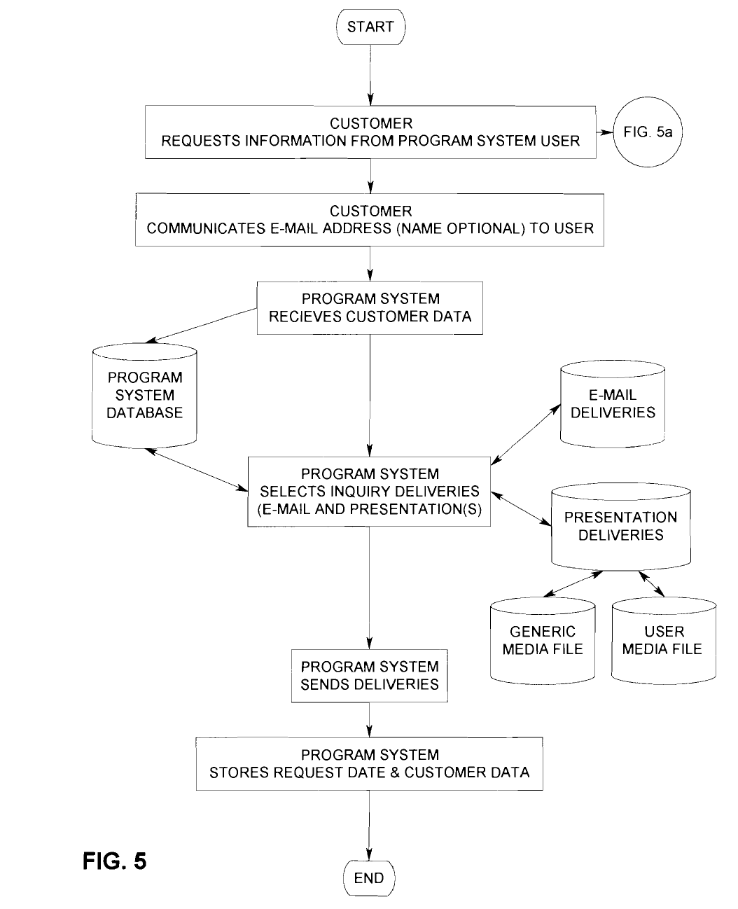

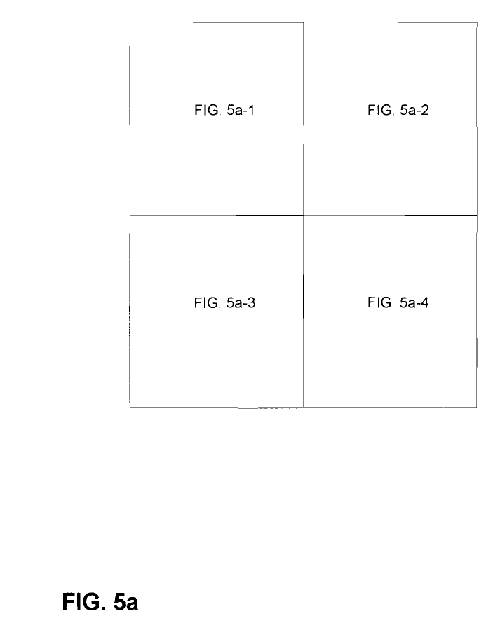

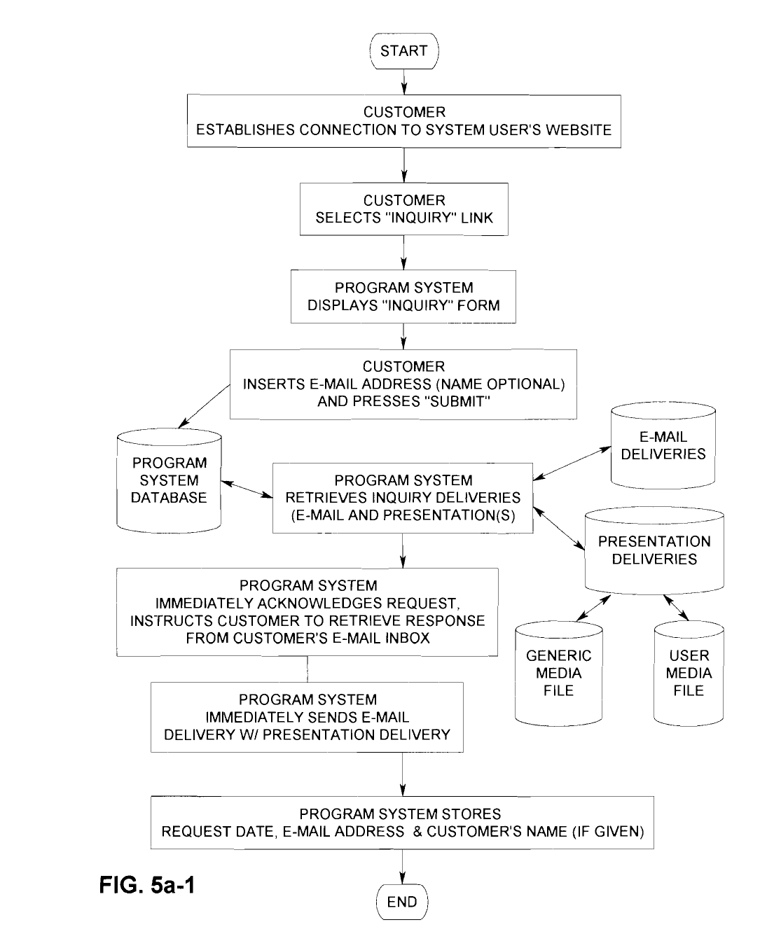

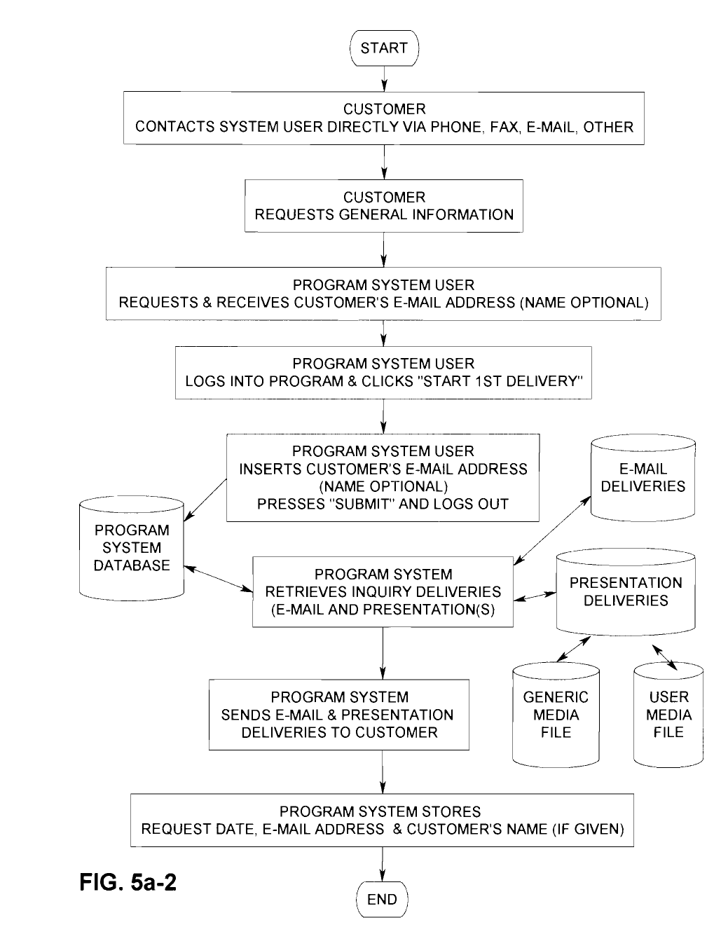

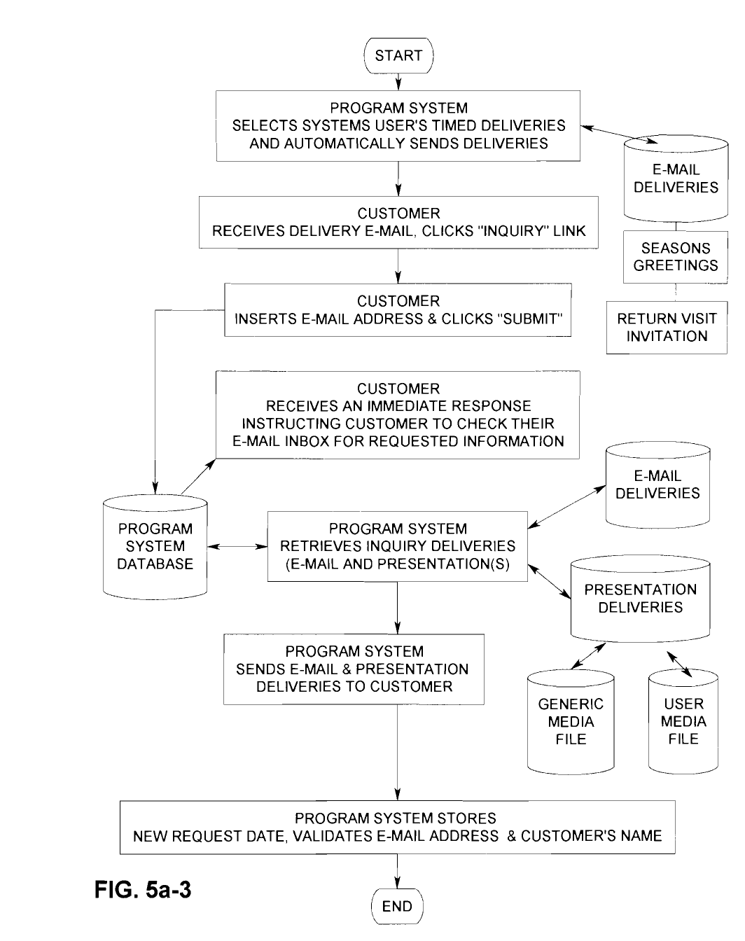

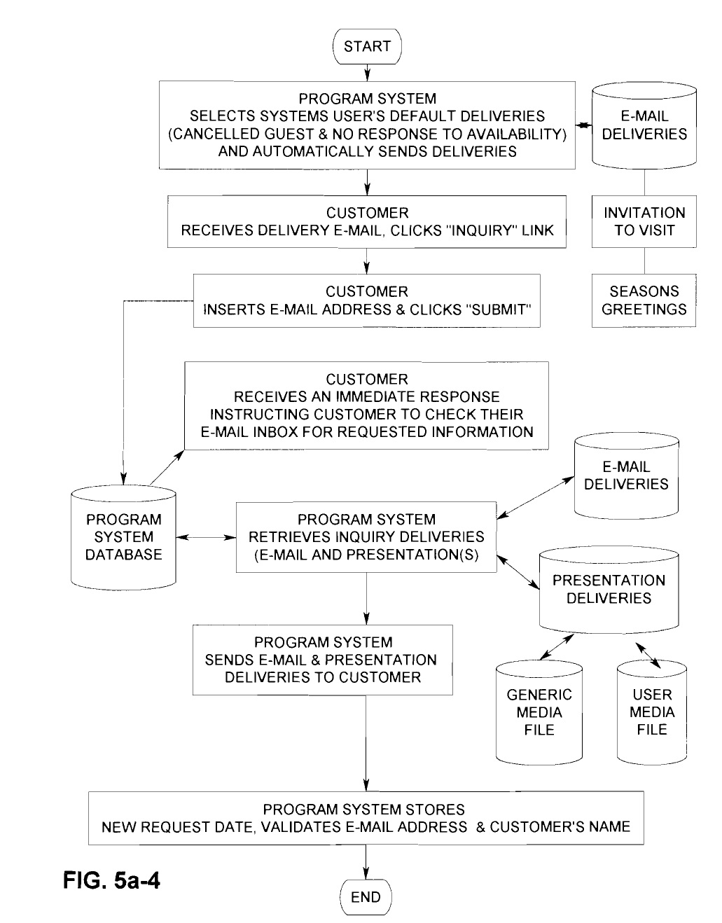

Step 8) Holiday Greetings Message—A Holiday Greeting e-mail is automatically delivered from the software program to the individual (guest/prospect/customer) at the appropriate time, based on the timeline stored in the software program. It also invites the individual to use the program system user's services again. NOTE: References are shown on this drawing for supporting drawings of the delivery sequence (FIG. 5 to FIG. 11) explaining more exact detail.

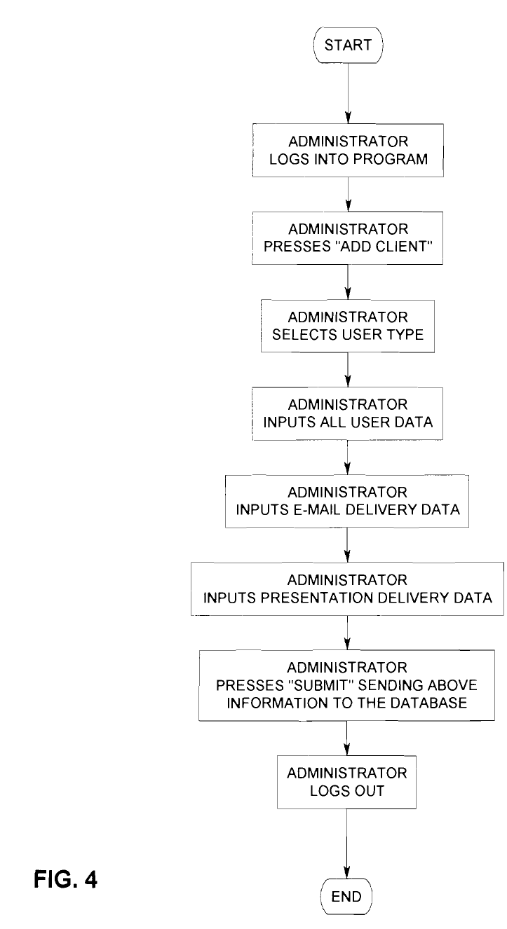

FIG. 4 describes the User Set-up by the program administrator. Each program system user, as in the hospitality industry for example, is given its own account with a login consisting of a username and password. The program administrator inputs all of the basic program system user's data into the program, plus the e-mail delivery data and presentation delivery data for the program system user. The data includes some or all, but limited to the following: type of property, brand identity logo, name, address, phone number, e-mail address, frequently asked questions, directions, local events, area interests, current weather conditions, rental agreements, rental rates/deposit information, rules & regulations, policies, check-in/checkout instructions, survey forms, suggestion forms, holiday greetings, return invitations, specials, the ability to plan a joint visit with family and/or friends and any other information deemed meaningful by the program system user. It also inserts the e-mail delivery data and presentation delivery data specific to the property. This data is stored in the program system's database. The e-mail delivery software program will automatically deliver some or all of the information that the participating program system user's normally communicates to their customer or potential customer in one form or another.

FIG. 5 is an overview of the Inquiry function which describes the interaction of the program system user and the potential customer via the invention. When an inquiry is made by a potential customer, in one form or other, their e-mail address is put into the program system's database and the inquiry delivery function is started. The program system acknowledges the request and advises the potential customer to check their inbox for an immediate response to the request. The program system automatically selects and delivers, via the Internet, an e-mail response with the appropriate data from its database, and the proper presentation delivery, similar in design to the participating program system user's Internet web site identity, from the program user's media file, and the generic media file in the form of a static and/or flash presentation, PDF document or other Internet related method of communication, to the potential customer.

The presentation deliveries can also be accomplished via the Internet through e-mail deliveries with links to web pages, including static web pages, audio/visual flash presentations, videos, slide shows, PDF documents, and/or any other type of Internet delivery presentation and can be similar in design to the participating businesses' Internet web site identity. This e-mail will typically ask the potential customer for a specific reply by completing and submitting a different request form, which is received by the participating program user in the form of an e-mail via the Internet. NOTE: Reference is shown on this drawing for supporting drawings of the variations to the inquiry function (FIG. 5a).

FIG. 5a is a block drawing showing the various methods which can be used to initiate the Inquiry function: in FIG. 5a-1 from a program system user's website; in FIG. 5a-2 from a direct contact from an individual (guest/prospect/customer); in FIG. 5a-3 from a timed delivery; and in FIG. 5a-4 from a default delivery.

FIG. 5a-1 is a flow chart depicting how an inquiry is made from a program user's website. An individual (guest/prospect/customer) establishes an Internet connection to a program user's website and selects the “inquiry” link. The program system displays a simple inquiry form, from the database for the program system user, that asks for the individual to insert their e-mail address, and name (if desired), and pressing “submit”.

The program automatically displays a response, acknowledging the request and suggesting the customer check their e-mail inbox for an immediate reply to the request.

The program system automatically selects and delivers, via the Internet, an e-mail response with the appropriate data from its database and the proper presentation delivery, similar in design to the participating program system user's Internet web site identity, from the program user's media file, and the generic media file in the form of a static and/or flash presentation, PDF document or other Internet related method of communication, to the individual. The presentation deliveries can also be accomplished via the Internet through e-mail deliveries with links to web pages, including static web pages, audio/visual flash presentations, videos, slide shows, PDF documents, and/or any other type of Internet delivery presentation and can be similar in design to the participating businesses' Internet web site identity. This e-mail will typically ask the potential customer for a specific reply by completing and submitting a different request form, which is received by the participating program user in the form of an e-mail via the Internet. The program system stores the date of inquiry, e-mail address and customer's name, if given.

FIG. 5a-2 is a flow chart depicting how an inquiry is made by means of a direct contact from an individual (guest/prospect/customer) to a program system user via phone, fax, e-mail, or other means of communication. The program system user would request and receive the individual's e-mail address and name, which is optional. The program system user would log into the program system, click “Start 1^{st} Delivery”, insert the individual's e-mail address and name, if given, and click “submit”. The program system automatically selects and delivers, via the Internet, an e-mail with the appropriate data from its database and the proper presentation delivery, similar in design to the participating program system user's Internet web site identity, from the program user's media file, and the generic media file in the form of a static and/or flash presentation, PDF document or other Internet related method of communication, to the potential customer. The presentation deliveries can also be accomplished via the Internet through e-mail deliveries with links to web pages, including static web pages, audio/visual flash presentations, videos, slide shows, PDF documents, and/or any other type of Internet delivery presentation and can be similar in design to the participating businesses' Internet web site identity. This e-mail will typically ask the potential customer for a specific reply by completing and submitting a different request form, which is received by the participating program user in the form of an e-mail via the Internet. The program system stores the date of inquiry, e-mail address and customer's name, if inserted into the database for the program system user at this time.

FIG. 5a-3 is a flow chart depicting how an inquiry is made from a timed delivery from the database of the program system user. Timed deliveries include, but are not limited to: guests who stayed at a program system user's property; individuals who made an inquiry but did not request arrival and departure dates; individuals who made a reservation, but cancelled. All guests receive an invitation to visit at another time and a season's greetings message is delivered to all individuals in the database. The program system automatically selects the appropriate delivery from one of several possible deliveries and sends it to an individual (guest/prospect/customer) via e-mail at the appropriate time set-up in the database. The individual receives the e-mail delivery with the appropriate presentation delivery information, clicks the “inquiry” link of the delivery, completes the form and clicks “submit” which goes to the database for the program system user. The program system automatically displays a response, acknowledging the request and suggesting the customer check their e-mail inbox for an immediate reply to the request. The program system automatically selects and delivers, via the Internet, an e-mail with the appropriate data from its database and the proper presentation delivery, similar in design to the participating program system user's Internet web site identity, from the program user's media file, and the generic media file in the form of a static and/or flash presentation, PDF document or other Internet related method of communication, to the potential customer. The presentation deliveries can also be accomplished via the Internet through e-mail deliveries with links to web pages, including static web pages, audio/visual flash presentations, videos, slide shows, PDF documents, and/or any other type of Internet delivery presentation and can be similar in design to the participating businesses' Internet web site identity. This e-mail will typically ask the potential customer for a specific reply by completing and submitting a different request form, which is received by the participating program user in the form of an e-mail via the Internet. The program system stores the new date of inquiry, verifies the individual's name and e-mail address in the database for the Program system user.

FIG. 5a-4 is a flow chart depicting how an inquiry is made from a default delivery from the database of the program system user. Default deliveries include, but are not limited to: guests who cancelled a reservation; guests who did respond to availability of requested dates. They receive a “missed having you” message and an invitation to visit the property, plus a season's greetings message. The program system automatically selects the appropriate delivery from one of several possible deliveries and sends it to an individual (guest/prospect/customer) via e-mail at the appropriate time set-up in the database. The individual receives the e-mail delivery with the appropriate presentation delivery information, clicks the “inquiry” link of the delivery, completes the form and clicks “submit” which goes to the database for the program system user. The program system automatically displays a response, acknowledging the request and suggesting the individual check their e-mail inbox for an immediate reply to the request. The program system automatically selects and delivers, via the Internet, an e-mail with the appropriate data from its database and the proper presentation delivery, similar in design to the participating program system user's Internet web site identity, from the program user's media file, and the generic media file in the form of a static and/or flash presentation, PDF document or other Internet related method of communication, to the potential customer. The presentation deliveries can also be accomplished via the Internet through e-mail deliveries with links to web pages, including static web pages, audio/visual flash presentations, videos, slide shows, PDF documents, and/or any other type of Internet delivery presentation and can be similar in design to the participating program user's Internet web site identity. This e-mail will typically ask the potential customer for a specific reply by completing and submitting a different request form, which is received by the participating program user in the form of an e-mail via the Internet. The program system stores the new date of inquiry, verifies the customer's name and e-mail address in the Program system user's database.

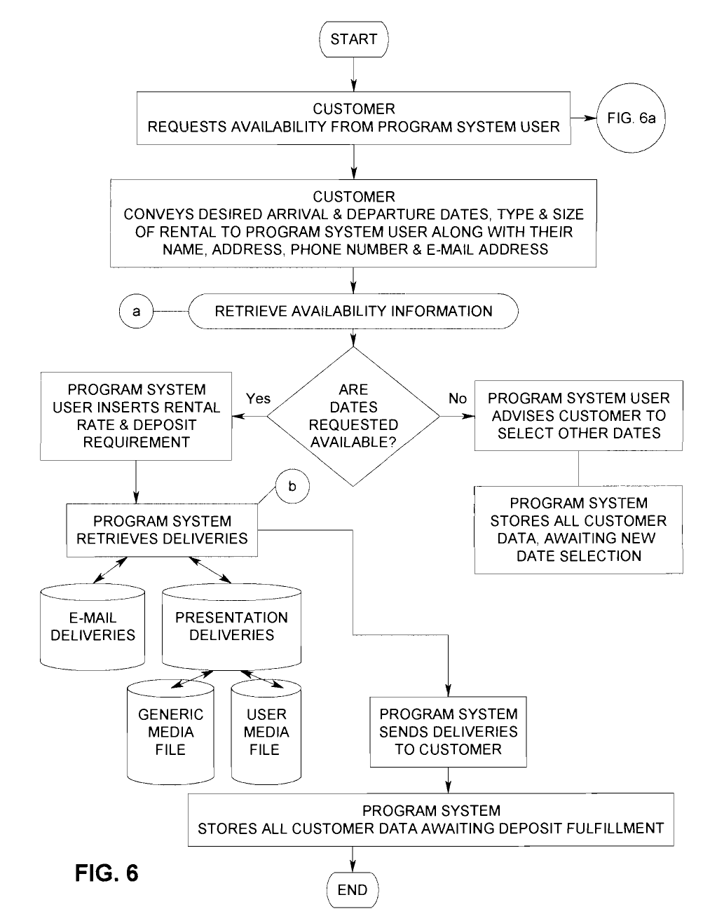

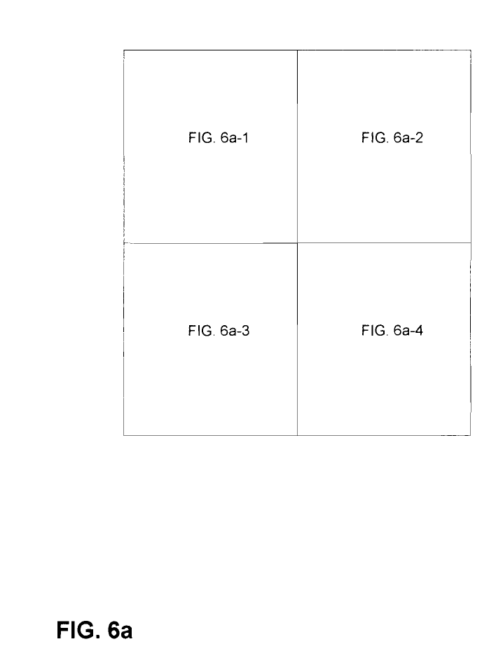

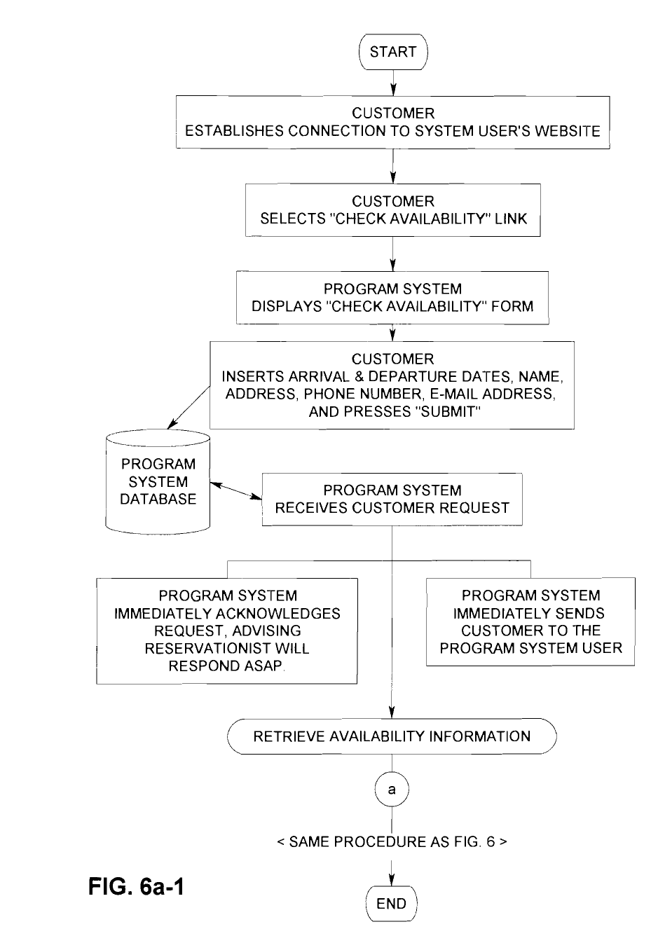

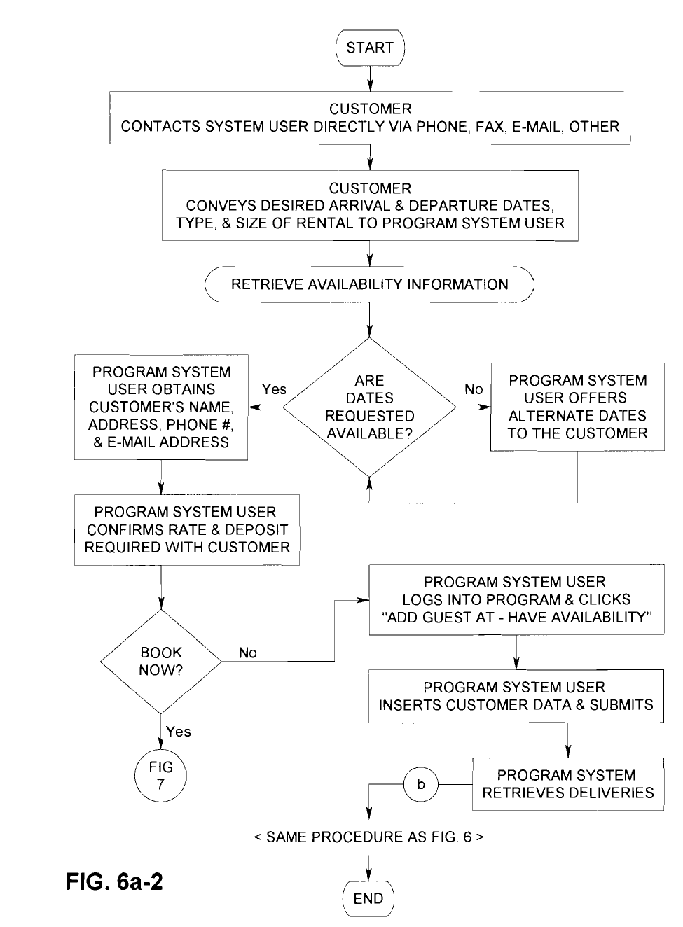

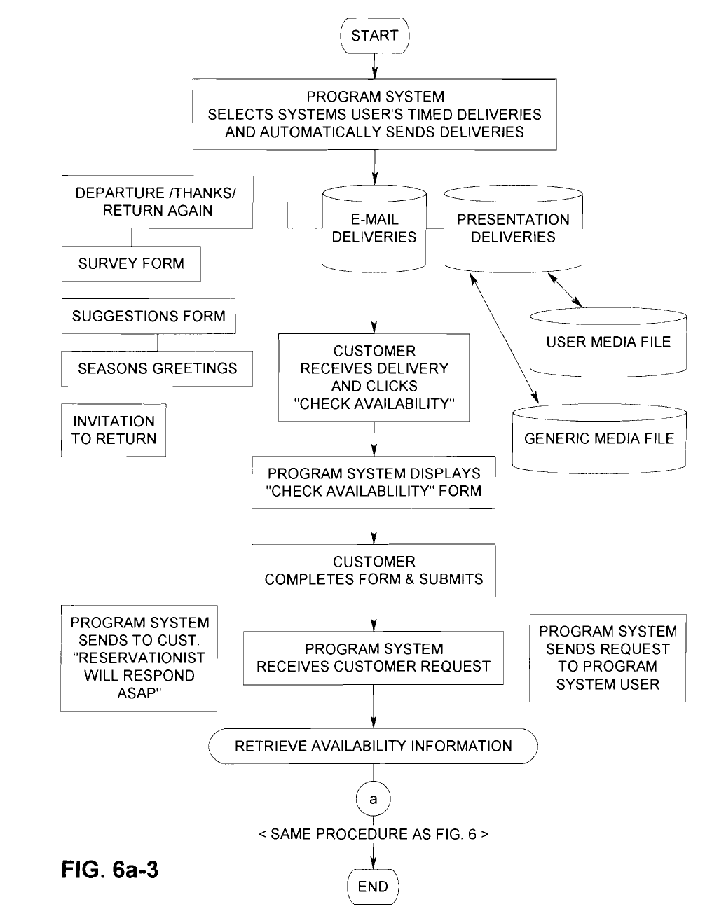

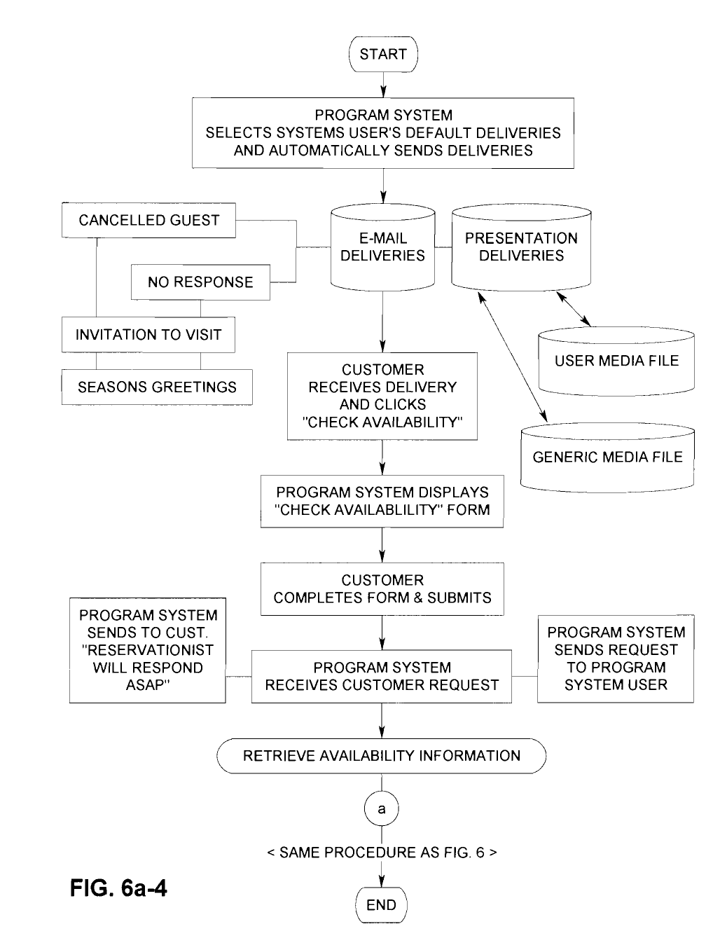

FIG. 6 is an overview of the Check Availability function which describes the interaction of the program system user and the potential customer via the invention. When an availability request is made by a potential customer, in one form or other, their requested arrival dates and departure dates, type and size of the rental, is conveyed to the program system and the program system user simultaneously, along with their name and e-mail address and put into the program system's database and the check availability delivery function is started. The program system immediately acknowledges the request and advises the potential customer that the reservationist will respond as soon as possible to the request. The program system user retrieves the data regarding the requested dates, confirms if requested dates are available and proceeds accordingly; if “yes”, the program system user fogs into the program system, locates the customer data in the program system, clicks “YES” to the request, inserts the rental rate and deposit requirement into the form and “submits”. The program system selects the appropriate e-mail and presentation deliveries, with the proper information from the program system user's media file, and send them to the customer's e-mail address via the Internet. The presentation delivery encourages the potential customer to lock-in the requested dates as soon as possible by fulfilling the deposit requirements. The program system stores the entire customer data awaiting deposit fulfillment by the potential customer. If “no”, the program system user locates the potential customer's data in the program system, clicks “NO” to the request, the program system delivers an e-mail to the potential customer advising them to select other dates that are available and/or contact the reservationist directly. All of the data is stored in the program system's database. The program system user logs out of the program system.

FIG. 6a is a block drawing showing the various methods which can be used to initiate the Check Availability function: in FIG. 6a-1 from a program system user's website; in FIG. 6a-2 from a direct contact form an individual; in FIG. 6a-3 from a timed delivery; and in FIG. 6a-4 from a default delivery.

FIG. 6a-1 is a flow chart depicting how a request for availability is made from a program user's website. An individual (guest/prospect/customer) establishes an Internet connection to a program user's website and selects the “check availability” link. The program system displays a simple form, from the database for the program system user, asking for the individual to insert their name, address, e-mail address, phone number, arrival and departure dates desired, type and size of rental. Once completed, the individual presses “submit” and the information is captured by the program system, stored in its database and sent to the program system user's e-mail via the internet. The program system immediately acknowledges the request and advises the individual that the reservationist will respond as soon as possible to the request.

The program system user receives the e-mail request, retrieves the data regarding the requested dates, confirms if requested dates are available and proceeds accordingly; if “yes”, the program system user logs into the program system, clicks “Add Guest At—Check Availability”. The program system user inserts the customer data into the form that appears, the program system, clicks “YES” to the request, inserts the rental rate and deposit requirement into the form and “submits”. The program system selects the appropriate e-mail and presentation deliveries, with the proper information from the program system user's media file, and send them to the customer's e-mail address via the Internet. The presentation delivery encourages the customer to lock-in the requested dates as soon as possible by fulfilling the deposit requirements. The program system stores the entire customer data awaiting deposit fulfillment by the customer. If “no”, the program system user locates the customer data in the program system, clicks “NO” to the request, the program system delivers an e-mail to the customer advising them to select other dates that are available and/or contact the reservationist directly. All of the data is stored in the program system's database. The program system user logs out of the program system.

FIG. 6a-2 is a flow chart depicting how a request for availability by means of a direct contact from an individual (guest/prospect/customer) to a program system user via phone, fax, e-mail, or other means of communication. The program system user would request and receive the individual's arrival and departure dates, type and size of the desired rental, plus their name, address, e-mail address, and phone number. The program system user retrieves the data regarding the requested dates, confirms if requested dates are available and proceeds accordingly; if they are, the program system user invites the individual to book the reservation. If the dates are not available, the program system user suggest dates that are available and invites the individual to book the reservation.

If the individual is not ready to book the reservation, the program system user offers to confirm the availability of the dates via e-mail. The program system user logs into the program system, clicks “Add Guest At—Confirm Availability”, inserts the customer data and clicks “Submit”. The program system selects the appropriate e-mail and presentation deliveries, with the proper information from the program system user's media file, and send them to the customer's e-mail address via the Internet. The presentation delivery encourages the customer to lock-in the requested dates as soon as possible by fulfilling the deposit requirements. The program system stores the entire customer data awaiting deposit fulfillment by the individual. The program system user logs out of the program system.

FIG. 6a-3 is a flow chart depicting how a request for availability from a timed delivery sent from the database of the program system user. Timed deliveries include, but are not limited to: guests who stayed at a program system user's property; potential guests who made an inquiry but did not request arrival and departure dates. An invitation to visit at another time and a season's greetings message are typical deliveries. The program system automatically selects the appropriate delivery from one of several possible deliveries and sends it to an individual (guest/prospect/customer) via e-mail at the appropriate time set-up in the database. The individual receives the e-mail delivery with the appropriate presentation delivery information and clicks the “check availability” link on the delivery. The program system displays a simple form, from the database for the program system user, asking for the individual to insert their name, address, e-mail address, phone number, arrival and departure dates desired, type and size of rental. Once completed, the individual presses “submit” and the information is captured by the program system, stored in its database and sent to the program system user's e-mail via the internet. The program system immediately acknowledges the request and advises the customer that the reservationist will respond as soon as possible to the request. The program system user receives the e-mail request, retrieves the data regarding the requested dates, confirms if requested dates are available and proceeds accordingly; if “yes”, the program system user logs into the program system, locates the customer data in the program system, clicks “YES” to the request, inserts the rental rate and deposit requirement into the form and “submits”. The program system automatically selects and delivers, via the Internet, an e-mail with the appropriate data from its database and the proper presentation delivery, similar in design to the participating program system user's Internet web site identity, from the program user's media file, and the generic media 111e in the form of a static and/or flash presentation, PDF document or other Internet related method of communication, to the potential customer. The presentation delivery encourages the potential customer to lock-in the requested dates as soon as possible by fulfilling the deposit requirements. The program system stores the entire customer data awaiting deposit fulfillment by the potential customer. If “no”, the program system user locates the customer data in the program system, clicks “NO” to the request, the program system delivers an e-mail to the customer advising them to select other dates that are available and/or contact the reservationist directly. All of the data is stored in the program system's database. The program system user logs out of the program system.

FIG. 6a-4 is a flow chart depicting how a request for availability from a default delivery sent from the database of the program system user. Default deliveries include, but are not limited to: guests who cancelled a reservation; guests who did respond to availability of requested date. An invitation to visit the property in the future and a season's greetings message are typical deliveries. The program system automatically selects the appropriate delivery from one of several possible deliveries and sends it to an individual (guest/prospect/customer) via e-mail at the appropriate time set-up in the database. The potential customer receives the e-mail delivery with the appropriate presentation delivery information and clicks the “check availability” link on the delivery. The program system displays a simple form, from the database for the program system user, asking for the potential customer to insert their name, address, e-mail address, phone number, arrival and departure dates desired, type and size of rental. Once completed, the individual presses “submit” and the information is captured by the program system, stored in its database and sent to the program system user's e-mail via the internet. The program system immediately acknowledges the request and advises the potential customer that the reservationist will respond as soon as possible to the request. The program system user receives the e-mail request, retrieves the data regarding the requested dates, confirms if requested dates are available and proceeds accordingly; if “yes”, the program system user logs into the program system, locates the customer data in the program system, clicks “YES” to the request, inserts the rental rate and deposit requirement into the form and “submits”. The program system automatically selects and delivers, via the Internet, an e-mail with the appropriate data from its database and the proper presentation delivery, similar in design to the participating program system user's Internet web site identity, from the program user's media file, and the generic media file in the form of a static and/or flash presentation, PDF document or other Internet related method of communication, to the potential customer. The presentation delivery encourages the customer to lock-in the requested dates as soon as possible by fulfilling the deposit requirements. The program system stores the entire customer data awaiting deposit fulfillment by the potential customer. If “no”, the program system user locates the customer data in the program system, clicks “NO” to the request, the program system delivers an e-mail to the potential customer advising them to select other dates that are available and/or contact the reservationist directly. All of the data is stored in the program system's database. The program system user logs out of the program system.

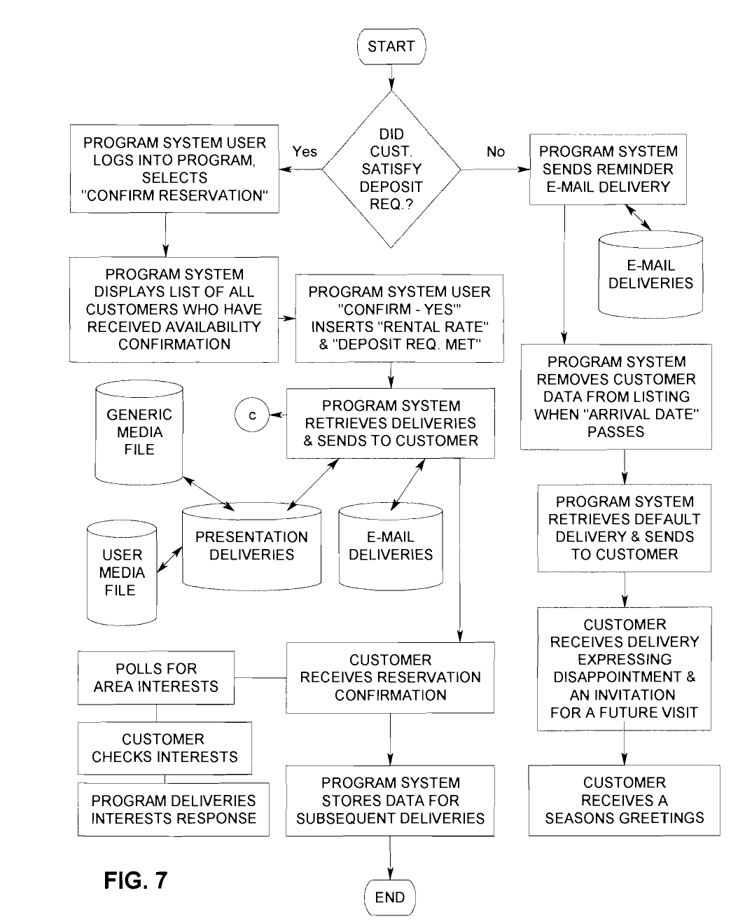

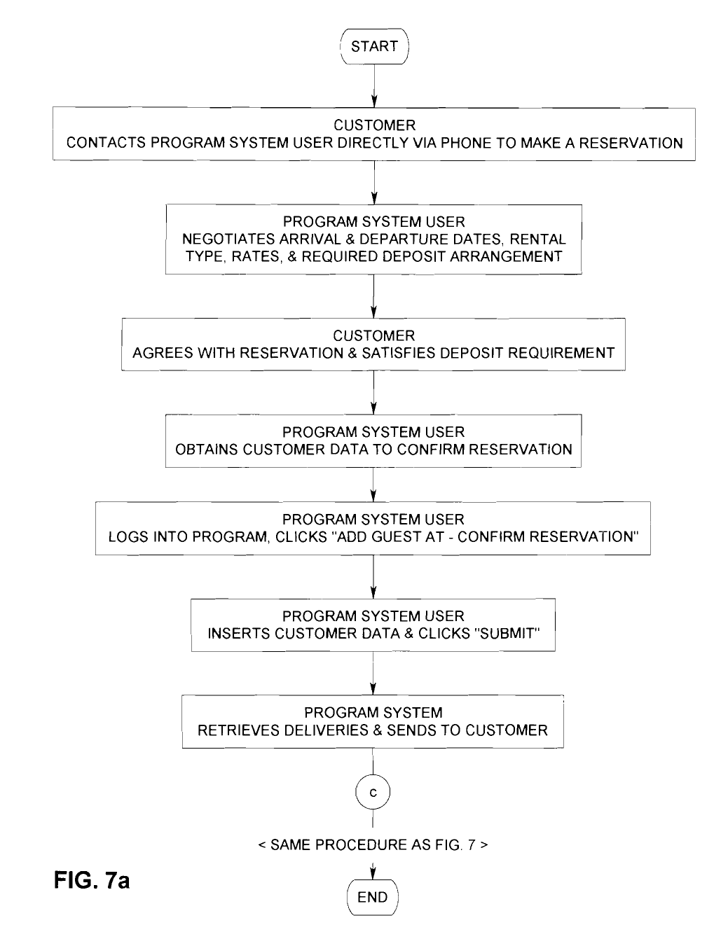

FIG. 7 describes the Confirm Reservation function. Upon receipt of the requested information, deposit, funding, and/or other required action by the individual (guest/prospect/customer), the program system user logs into the program system and selects “Confirm Reservation”. The program system displays a list of all individual s who have received availability confirmation. The program system user locates the individual's data, clicks “Confirm”, then “YES” and the program system displays the “confirm reservation” form. The program system user inserts the rental rate, indicates that the deposit requirement is met and presses “Submit”. The program system automatically selects and delivers, via the Internet, an e-mail with the appropriate data from its database and the proper presentation delivery, similar in design to the participating program system user's Internet web site identity, from the program system user's media file and the generic media file, in the form of a static and/or flash presentation, PDF document or other Internet related method of communication, confirming the reservation with the customer. The delivery also assists the guest/customer in planning activities and/or other possible interests in the area by polling the individual for their specific area interests. The guest/customer can select from a list of many and various different interests by checking the appropriate check boxes on a form and clicking the submit button. The customer will immediately receive a message to check their inbox for a response to their requested interests. The program system stores the data, including the customer's area interests which will be delivered again with the “Check-in” delivery. The program system stores all data for subsequent deliveries. If the individual (guest/prospect/customer) does not fulfill the deposit requirement is a reasonable time, a reminder is sent automatically prompting the individual to do so. If there is still no response by the time the “arrival date” stored in the database passes, the program system removes the individual from the list. The program system retrieves and sends two default deliveries, timed appropriate as set-up in the database, to the individual. The first default delivery expresses disappointment that the individual was unable to book the reservation at this time and invites the individual to do so in the future. The second default delivery is a “Seasons Greetings” delivery, inviting a visit from the individual.

FIG. 7a describes the Confirm Reservation function resulting from a direct contact from an individual (guest/prospect/customer) to a program system user via phone, fax, e-mail, or other means of communication. The program system user would request and receive the potential customer's arrival and departure dates, type and size of the desired rental, plus their name, address, e-mail address, and phone number. The program system user retrieves the data regarding the requested dates, confirms if requested dates are available and proceeds accordingly; if they are, the program system user invites the potential customer to book the reservation. If the dates are not available, the program system user suggest dates that are available and invites the potential customer to book the reservation. If the potential customer books the reservation and satisfies the is deposit requirement, the program system user logs into the program system, clicks “Add Guest At—Confirm Reservation”. The program system displays the “confirm reservation” form. The program system user inserts the customer's name, address, phone number, e-mail address, rental rate, indicates that the deposit requirement is met and presses “Submit”. The program system automatically selects and delivers, via the Internet, an e-mail with the appropriate data from its database and the proper presentation delivery, similar in design to the participating program system user's Internet web site identity, from the program system user's media file and the generic media file, in the form of a static and/or flash presentation, PDF document or other Internet related method of communication, confirming the reservation with the customer. The delivery also assists the customer in planning activities and/or other possible interests in the area by polling the individual for their specific area interests. The customer can select from a list of many and various different interests by checking the appropriate check boxes on a form and clicking the submit button. The guest/customer will immediately receive a message to check their inbox for a response to their requested interests. The program system stores the data, including the guest/customer's area interests which will be delivered again with the “Check-in” delivery. The program system stores all data for subsequent deliveries.

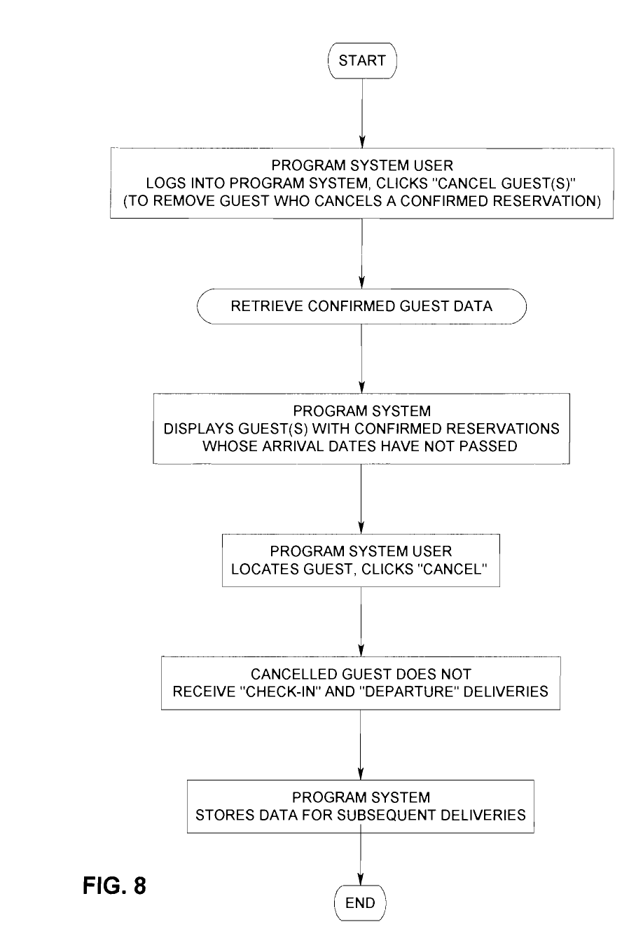

FIG. 8 is a flow chart depicting the Cancelled Guest function. If a customer cancels a reservation that was already entered into the program system, the program system user logs into the program system, clicks “Cancel Guest(s)”. The program system retrieves the confirmed guest data and displays a list of confirmed guests whose arrival dates are still current. The program system user locates the guest who is canceling their reservation, and clicks “Cancel”. The program system changes the customer status from a reservation customer to a cancelled customer so that the customer does not receive the check-in and departure (check-out) deliveries. The program system stores the data for the appropriate subsequent deliveries. The program system retrieves and delivers a default that expresses disappointment that the customer was unable to keep the reservation at this time and invites the customer to do so in the future. The program system retrieves and delivers a second default delivery, timed to the original inquiry date, extending an invitation to the customer to visit the property, and a third default delivery is a “Seasons Greetings” delivery sent during the holidays.

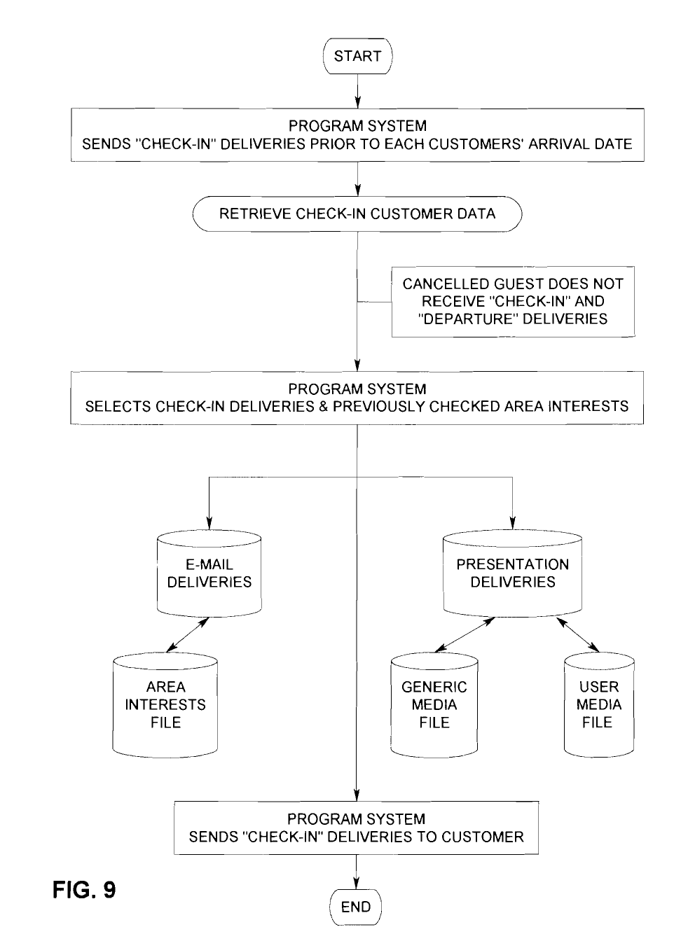

FIG. 9 is a flow chart depicting the Check-in function. Prior to the arrival date of each customer, the program system retrieves the check-in customer data, selects and sends via the Internet, an e-mail with the appropriate data from its database and the proper presentation delivery, similar in design to the participating program system user's Internet web site identity, from the program system user's media file and the generic media file, in the form of a static and/or flash presentation, PDF document or other Internet related method of communication, offering information relative to the check-in of the customer. The program system also retrieves the customer's previously checked area interests and re-delivers them at this time. The program system stores all data for subsequent deliveries.

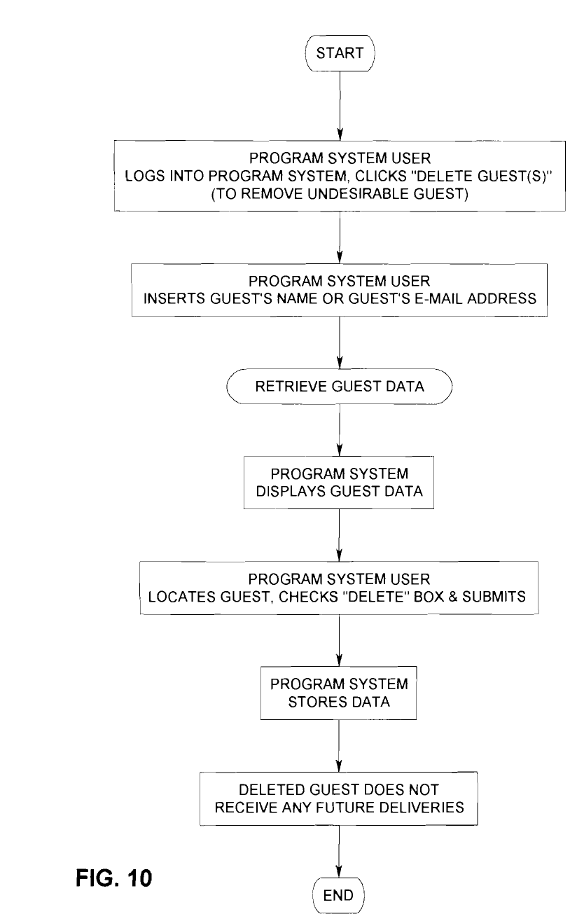

FIG. 10 is a flow chart depicting the Deleted Guest function to remove an undesirable customer from receiving any of the follow-up deliveries. The program system user logs into the program system, clicks “Delete Guest(s)”. The program system displays a form allowing the program system user to search the database by a customer's name or e-mail address. The program system user inserts the name or e-mail address of the undesirable customer, clicks “FIND”. The program system displays a form with the customer identified. The program system user checks the box next to the customer and clicks “Delete”. The program system removes all data relating to the deleted customer. The deleted customer receives no more deliveries from the program system.

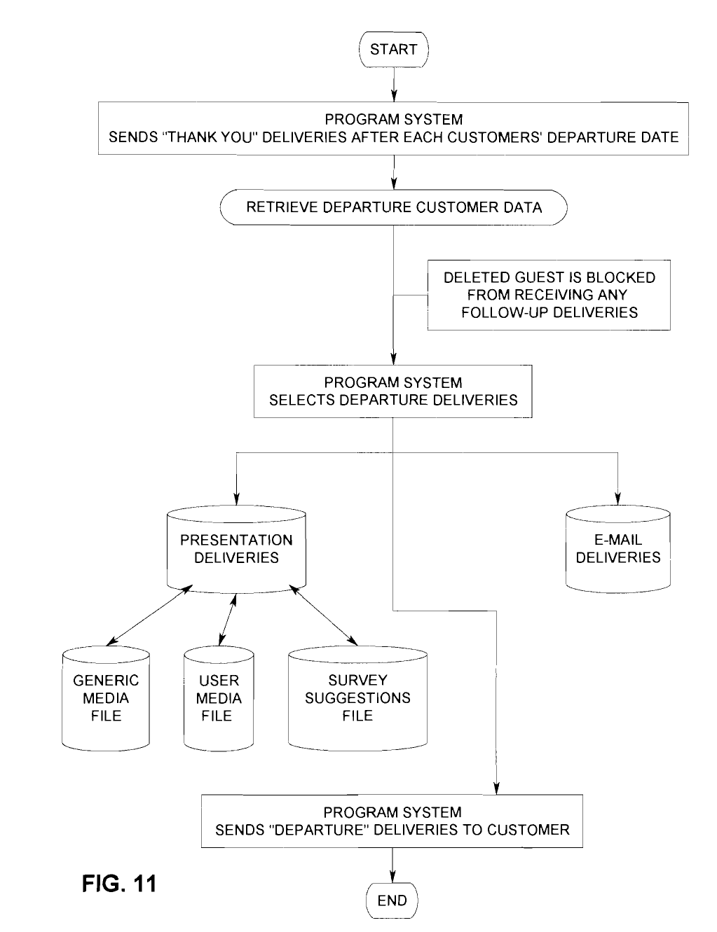

FIG. 11 describes the Departure (check-out) function. Timed to the customer's departure date, the program system retrieves and sends via the Internet a “Thank You” e-mail and the proper presentation delivery, similar in design to the participating program system user's Internet web site identity, from the program system user's media file and the generic media file, in the form of a static and/or flash presentation, PDF document or other Internet related method of communication, confirming the reservation with the customer. This delivery generally thanks the customer for their business and offers a survey form and a suggestion form for the customer to complete and submit, which is received by the participating program system user in the form of an e-mail via the Internet. It also encourages the individual to use the business' services again by inviting them to complete a new “Inquiry” form. The program system stores all data for subsequent deliveries.

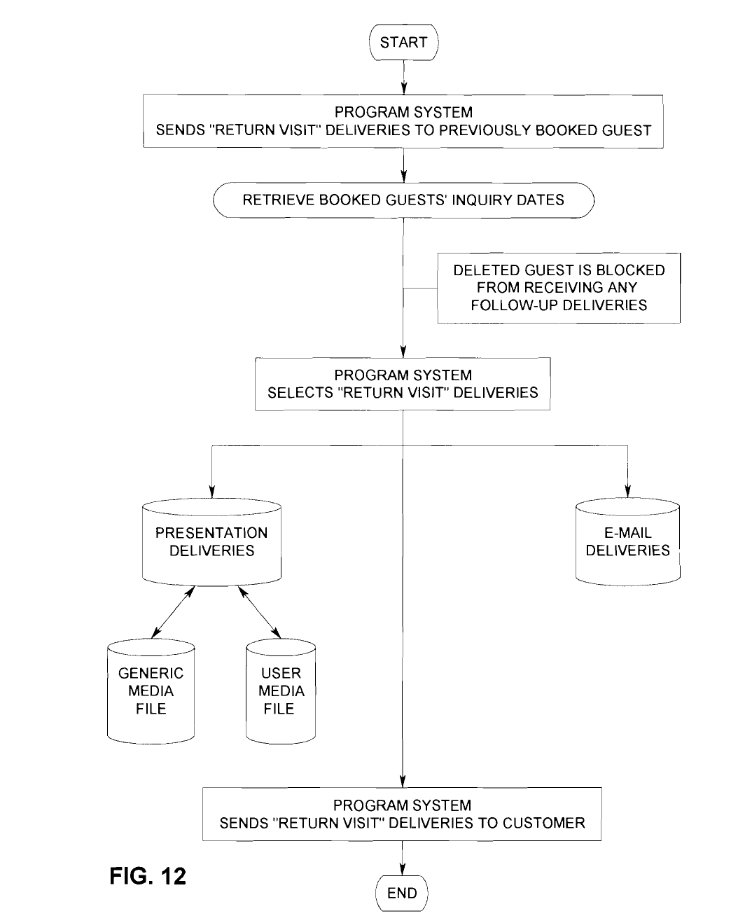

FIG. 12 describes the Return Visit Invitation function. Timed to the customer's original inquiry date, the program system automatically retrieves the booked guests' inquiry dates and sends via the Internet an “Invitation to Return” message e-mail along with the proper presentation delivery, similar in design to the participating program system user's Internet web site identity, from the program system user's media file and the generic media file, in the form of a static and/or flash presentation, PDF document or other Internet related method of communication, confirming the reservation with the customer. This delivery generally encourages the individual to use the business' services again by inviting them to complete a new “Inquiry” form and a “Check Availability” form The program system stores all data in the database.

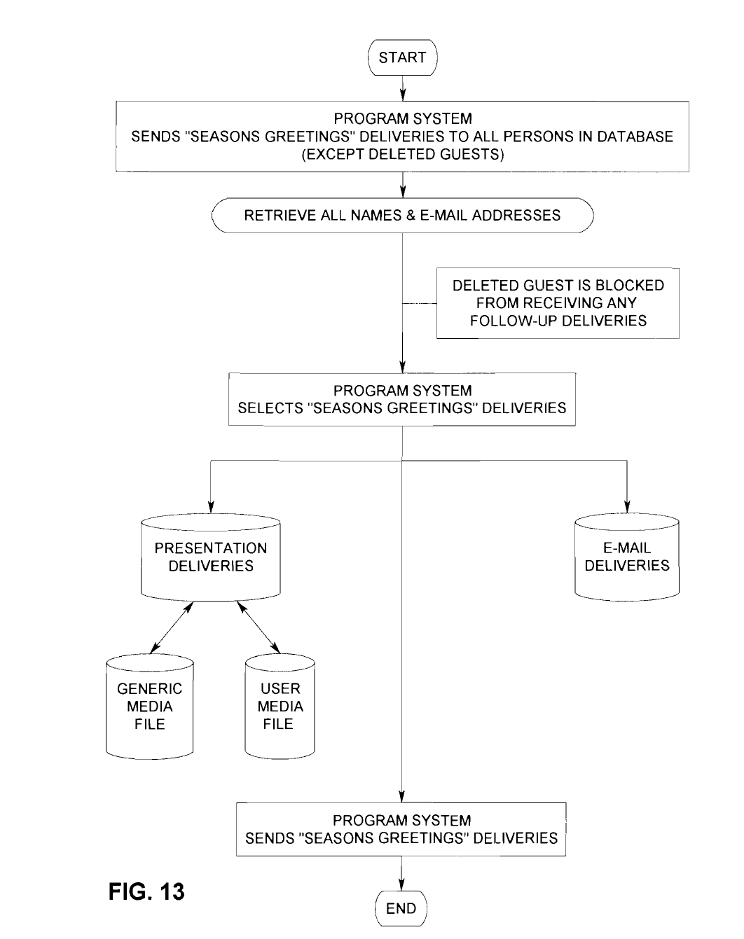

FIG. 13 describes the Seasons Greetings function. Timed appropriately, all individuals (guest/prospect/customer) in the program system's database automatically receive a “Seasons Greetings” message e-mail and the proper presentation delivery, similar in design to the participating program system user's Internet web site identity, from the program system user's media file and the generic media file, in the form of a static and/or flash presentation, PDF document or other Internet related method of communication, wishing the customer good will.

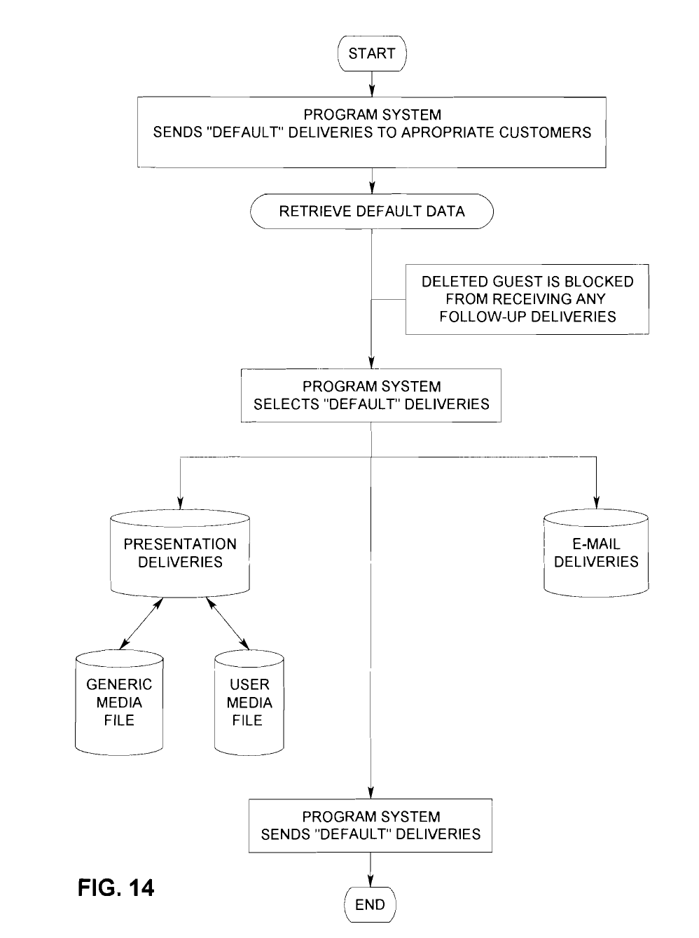

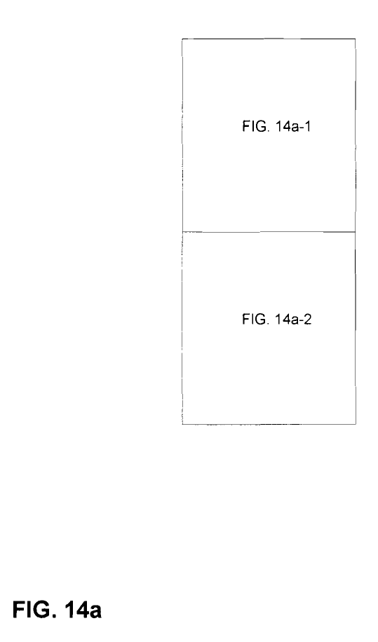

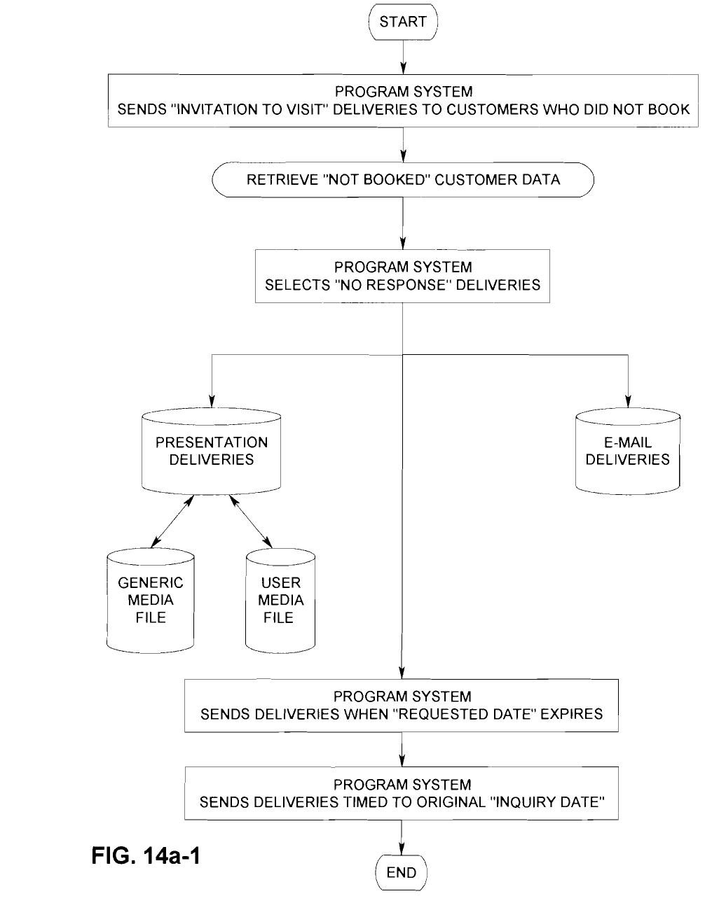

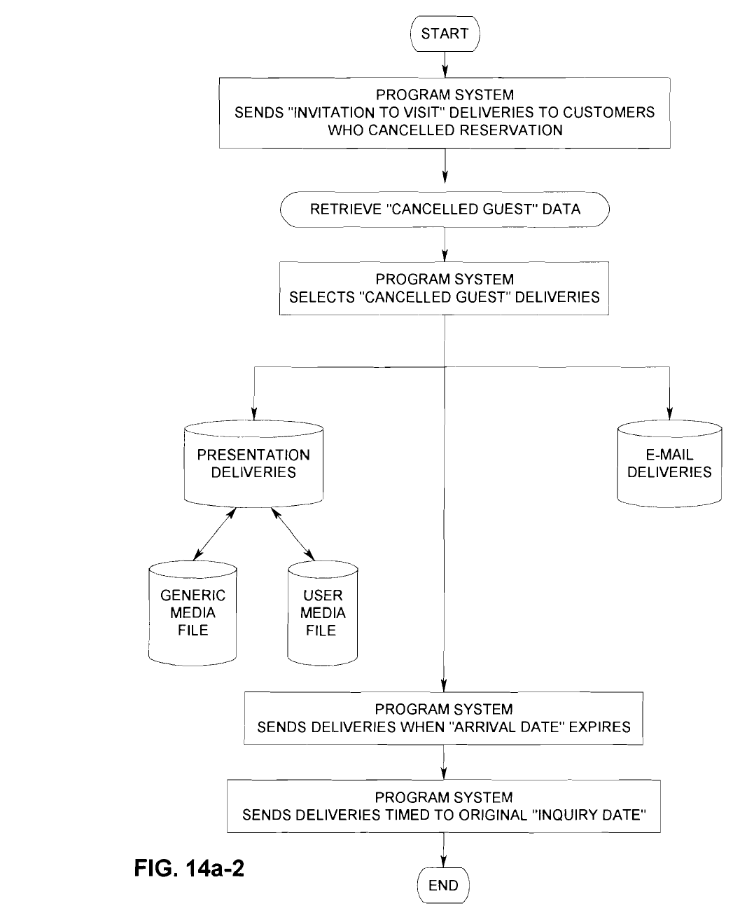

FIG. 14 is an overview of the Default Delivery function which describes the selection and retrieval process used by the program system. Timed according to the inquiry date and/or requested arrival date of an individual (guest/prospect/customer), the program system retrieves the default delivery data, selects, and sends the e-mail delivery and the proper presentation delivery, similar in design to the participating program system user's Internet web site identity, from the program system user's media file and the generic media file, in the form of a static and/or flash presentation, PDF document or other Internet related method of communication to the individual. Typical default deliveries include, but are not limited to the following: individuals who became customers; individuals who requested information, but did not become a customer; customers who booked a reservation, then cancelled.

FIG. 14a is a block drawing showing various types of the default function: in FIG. 14a-1 a default delivery is sent to an individual who did not respond to having a requested availability; in FIG. 14a-2 a default delivery is sent to an individual who booked a reservation, then cancelled the reservation.

FIG. 14a-1 describes the No Response default function. If an individual who requests availability and receives notice that their request can be filled, but does book a reservation, the program system automatically retrieves the potential customer's data, selects the No Response data, then sends via the Internet an “Invitation to visit in the future” message e-mail along with the proper presentation delivery, similar in design to the participating program system user's Internet web site identity, from the program system user's media file and the generic media file, in the form of a static and/or flash presentation, PDF document or other Internet related method of communication, confirming the reservation with the customer. This delivery generally encourages the individual to consider the business' services in the future by inviting them to complete a new “Inquiry” form and a “Check Availability” form. The potential customer also receives the “Seasons Greetings” delivery at the appropriate time.

FIG. 14a-2 describes the Cancelled Guest default function. If an individual (guest/prospect/customer) books a reservation, but cancels the reservation, the program system automatically retrieves the cancelled customer's data, selects the Cancelled Guest deliveries, then sends via the Internet an “Invitation to visit in the future” message e-mail along with the proper presentation delivery, similar in design to the participating program system user's Internet web site identity, from the program system user's media file and the generic media file, in the form of a static and/or flash presentation, PDF document or other Internet related method of communication, confirming the reservation with the customer. This delivery generally expresses regrets and encourages the individual to consider the business' services in the future by inviting them to complete a new “Inquiry” form and a “Check Availability” form. The potential customer also receives the “Seasons Greetings” delivery at the appropriate time.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims It is indeed intended that the scope of the invention should be determined by proper interpretation and construction of the appended claims and their legal equivalents, as understood by those of skill in the art relying upon the disclosure in this specification and the attached drawings.

1. A computer program product for assisting business inquiries by providing automatic e-mail delivery responses residing on a computer readable medium comprises instructions for causing a computer to:
produce an environment capable of handling an inquiry made by a potential customer and automatically responding to the inquiry by acknowledging the request and advise the potential customer to check their e-mail inbox for an immediate response to the request being delivered along with the proper presentation delivery media file to the potential customer.

2. The computer program product of claim 1 wherein the instructions that cause the computer to initiate the response sequence compromise instructions to cause the computer to: access a database of stored information to obtain the relevant requested information in response to the query.

3. The computer program product of claim 2 wherein the instructions that cause the computer to initiate the response sequence comprise instructions that cause the computer to query a predetermined timeline tied to the initial inquiry to invite the potential customer to again participate in the program system user's services.

4. A computer program product made up of a computer usable medium and computer readable program code means embodied in said medium for providing automatic e-mail delivery responses, said computer readable program code means comprising:
means for accepting an query over the Internet from a potential customer;
means for determining the information sought by the query;
means for accessing a database storing information responsive to the query;
means for automatically delivering to the potential customer the responsive information; and
means for scheduling follow up communications with potential customer based on actions taken by the potential customer.

5. The program of claim 4 further comprising means for authenticating the to accuracy and continued veracity of the responsive information.

6. The program of claim 5 wherein the means for delivering responsive information includes attaching media files coinciding with the responsive information and delivering both responsive information and supporting attached media files.

7. A computer-readable medium having computer executable instructions for providing automatic e-mail delivery responses, the computer-executable instructions performing steps comprising:
accepting an inquiry from a potential customer;
accessing responsive information stored in a database;
formulating response using information retrieved from the database;
attaching at least one media file containing additional information relative to the responsive information;
delivering response and additional information;
determining what if any action was taken by the potential customer;
accessing predetermined follow up response timeline;
comparing action taken with follow up response timeline;
formulating appropriate response based on timeline and action taken by customer;
transmitting appropriate follow up response to potential customer.
